(19) United States
(12) Patent Application Publication
(10) Pub. No.: US 2023/0039453 A1
(43) Pub. Date: Feb. 9, 2023

(54) A NUMERICALLY CONTROLLED TURNING CENTER WITH DOUBLE TURNING AXIS

(71) Applicant: PAOLINO BACCI S.R.L., Cascina (IT)

(72) Inventors: Giuseppe BACCI, Pontedera (IT); Nino BACCI, Pontedera (IT); Paolo BACCI, Pontedera (IT)

(21) Appl. No.: 17/793,111

(22) PCT Filed: Jan. 14, 2021
(86) PCT No.: PCT/EP2021/050702

§ 371 Date: Jul. 15, 2022

(30) Foreign Application Priority Data
Jan. 16, 2020 (IT) 102020000000718

(51) Int. Cl. G05B 19/18; B23B 3/32

(52) U.S. Cl. CPC G05B 19/182; B23B 3/32

(57) ABSTRACT

A numerically controlled turning center (1; 100), includes a support and rotation unit (19) having a first pair of support and rotation members (21, 23) aligned with each other along a first rotation axis (A1) and a second pair of support and rotation members (25, 27) aligned with each other along a second rotation axis (A2) parallel first rotation axis (A1). There is also provided a machining head (13) with a rotary tool (13.1) movable along a first numerically controlled translation axis (X) parallel to the rotation axes (A1, A2) of the first pair of support and rotation members and of the second pair of support and rotation members. The machining head (13, 15, 17) and the support and rotation unit (19) are movable one with respect to the other in a direction (Z) orthogonal to the first rotation axis (A1) of the first pair of support and rotation members (21, 23) and to the second rotation axis (A2) of the second pair of support and rotation members (25, 27).

### TECHNICAL FIELD

The present invention concerns the field of numerically controlled machine tools. More in particular, the invention concerns improvements to numerically controlled turning centers, i.e., machines capable of carrying out turning operations automatically, under the control of a suitably programmed control unit, which controls machining movements on a plurality of numerically controlled axes.

Embodiments described herein are configured in particular for turning operations of elongated workpieces, for example in wood, plastic or light alloys, such as, by way of non-limiting example, components of furniture in general, chairs, tables and other furnishing elements, components of stairs or the like, usually of elongated shape with rectilinear or curvilinear axes.

### BACKGROUND ART

Machining of elongated components, which require to be rotated about a support and rotation axis, is typically carried out in turning centers equipped with a pair of support and rotation members, commonly comprising a motorized headstock and a tailstock. Machining heads placed around the support and rotation axis of the workpieces to be machined carry machining tools that are selectively brought into the machining position against the workpiece supported between headstock and tailstock. Various numerically controlled approach and forward movements along a suitable number of numerically controlled axes are possible between workpiece being machined and tools.

These turning centers currently have some drawbacks, for example due to the difficulty of collecting and removing machining chips. Moreover, prior art turning centers are relatively limited in relation to the amount and type of machining operations that can be carried out. Furthermore, they have limits with regard to the number of workpieces that can be machined in each machining cycle.

To carry out turning operations on large workpieces the members for supporting and rotating the workpieces, and the machining tools and the related machining heads must be sized accordingly. Therefore, the turning center sized to machine large workpieces is utilized inefficiently when used to machine smaller workpieces. On the other hand, in industrial production, small workpieces are much more numerous than large workpieces. This means that those who invest in a turning center for large workpieces, which consequently has a relatively high cost, will often find themselves operating the turning center below its capacities, consequently extending the time necessary to amortize the cost of the turning center.

JP63-200937 discloses a machining center with a horizontal bed, on which two headstock and tailstock pairs are arranged, to support two workpieces to be machined. The two workpieces are supported with a high mutual center-to-center distance, to allow a single tool to machine the two workpieces separately. The tool is carried by a single machining head that translates along a cross member of a gantry structure. The cross member is oriented at 90° with respect to the rotation axes of the headstock and tailstock pairs. The headstocks and tailstocks are carried by a slide movable on the bed in a direction orthogonal to the cross member on which the machining head is mounted. The chips produced during machining collect on the slide which carries the headstock and tailstock pairs.

This prior art machining center has considerable drawbacks, among other things due to the length of the machining cycles and to the difficulty in removing the chips produced during machining. Moreover, it is capable of carrying out only a few kinds of machining operations on the workpieces.

Therefore, it would be advantageous to provide numerically controlled turning centers that totally or partially overcome one or more of the problems of prior art turning centers.

### SUMMARY

According to one aspect, there is described herein a numerically controlled turning center, comprising a support and rotation unit to support and rotate workpieces to be machined. The support and rotation unit comprises a first pair of support and rotation members, and a second pair of support and rotation members. Each pair of support and rotation members in turn comprises a motorized headstock and a tailstock, aligned with each other along a respective rotation axis of the workpiece. The axes along which the two pairs of support and rotation members are aligned are parallel to one another and spaced apart by a center-to-center distance. As will be apparent from the description of some embodiments, the center-to-center distance is such as to allow two workpieces to be machined in a single machining cycle, possibly acting on both workpieces simultaneously with the same tool. The term machining cycle is meant as the operations carried out on the workpiece or workpieces loaded in the machine, between the step of loading the unworked workpieces and the step of unloading the machined workpieces.

The support and rotation members can be controlled so as to carry out different angular movements, i.e., rotations about the respective axes, for the two pairs of support and rotation members, or to carry out the same angular movements, simultaneously, or staggered in time. Therefore, in general, according to some embodiments, the motorized headstocks of each pair of support and rotation members can be controlled by a control unit so as to carry out different angular movements at different times, or so as to carry out the same movements simultaneously.

According to embodiments described herein, the turning center further comprises at least one first machining head, in turn comprising a first rotary tool for chip removal machining, movable along a first numerically controlled translation axis parallel to the rotation axes of the first pair of support and rotation members and of the second pair of support and rotation members.

Advantageously, the travel of the machining head along the first numerically controlled translation axis can be such as to allow the respective tool to machine a workpiece along the whole of its length, i.e., along the whole of the dimension parallel to the rotation axis defined by the support and rotation members.

The machining head and the support and rotation unit are movable one with respect to the other in a direction orthogonal to the rotation axes of the first and of the second pair of support and rotation members, and consequently orthogonal to the first numerically controlled translation axis, and parallel to a plane on which the rotation axes of the first and of the second pair of support and rotation members lie. In this way, as will be apparent hereunder from the detail description of embodiments, the machining tool of the machining head can be positioned selectively at a workpiece to be machined carried by the first pair of support and rotation members or by the second pair of support and rotation members and the same turning center can be utilized to machine two workpieces supported simultaneously in the turning center, or a single larger workpiece.

This relative movement between machining head and support and rotation unit of the workpieces can be obtained with a numerically controlled translation axis. Alternatively, the movement can be an adjustment movement controlled manually or servo-assisted, i.e. performed by an actuator, without a numerical control, but performed using proximity sensors, for instance.

The turning center thus configured allows a single workpiece of large radial size, or selectively two workpieces of smaller radial size placed side by side, to be machined with the same members and in the same machining cycle. The term radial size is meant as the maximum size of the cross section of the workpiece, i.e., of the section orthogonal to a longitudinal axis of the workpiece to be machined. In the first case, the single workpiece is supported and rotated by one of the two pairs of support and rotation members, while in the second case each of the two workpieces to be machined is mounted on a respective of said two pairs of support and rotation members. The relative movement between tools and support and rotation unit in the direction parallel to the plane on which the support and rotation axes lies and orthogonally to these axes allows correct positioning of the tool with respect to the workpiece or workpieces to be machined.

To allow machining of workpieces of variable longitudinal size, the distance between each headstock and the respective tailstock can be adjustable. Preferably, the headstock is fixed with respect to a load-bearing member, for example a slide, while the tailstock is movable along the rotation axis to vary and adjust the distance with respect to the headstock as a function of the length of the workpiece to be supported.

In some currently preferred embodiments, the distance between the two headstocks and the respective two tailstocks is adjustable simultaneously, i.e., the distance between the support and rotation members of the first pair is always the same as the distance between the support and rotation members of the second pair. In this way, the structure of the machine is simplified and two workpieces of the same length can be machined in the same machining cycle. However, it would also be possible to adjust the distance between headstock and tailstock independently for the two headstock and tailstock pairs. This can be useful to machine two workpieces with different longitudinal sizes in a same machining cycle.

To facilitate machining of a single large workpiece, at least one headstock and corresponding tailstock can be detachable, to prevent them from hindering the tools during machining of a large workpiece, mounted between the other headstock and the other tailstock. In other embodiments, the support and rotation members of at least one pair and preferably of both pairs can be movable between a working position and a withdrawn idle position. In this way, it is, for example, possible to retract the two support and rotation members of one pair when not in use, while a single workpiece to be machined is supported by the other of the two pairs of support and rotation members. The pair of support and rotation members not in use remains outside the footprint and does not hinder machining of the workpiece supported by the other pair of support and rotation members.

The turning center configured with a support and rotation unit able to support and allow either two smaller workpieces or one larger workpiece to be machined is particularly versatile and compact. It will generally be sized to machine workpieces of a maximum size. When machining smaller workpieces, a substantial increase in productivity and consequently optimal exploitation of the machine are achieved due to the fact that the smaller workpieces can be machined in pairs.

In some embodiments, the support and rotation unit is provided with the relative movement between the machining head and the support and rotation unit, with respect to a stationary load-bearing structure, while the machining head is not provided with a movement in this direction. For example, the support and rotation unit can be carried by a slide movable on a bed or other support structure, preferably with a numerically controlled translation axis.

To facilitate collection and removal of the chips produced during machining, in some particularly advantageous embodiments the plane on which the rotation axes of the first and of the second pair of support and rotation members lie is substantially horizontal and the machining head is located over said plane. Moreover, the machining head and the support and rotation unit are movable one with respect to the other in a substantially horizontal direction. As indicated previously, the support and rotation unit is preferably provided with this horizontal movement, rather than the machining head.

In the present description and in the appended claims, the terms “vertical” and “horizontal” refer to the position taken by the turning center when installed in an operating position. The direction indicated as “vertical” is a direction parallel to the direction of the force of gravity, while the direction indicated as “horizontal” is a direction orthogonal to the direction of the force of gravity.

With a horizontal orientation of the plane on which the support and rotation axes of the workpieces lie, i.e., the axes along which each headstock and the respective tailstock are aligned, and arranging the machining tools over said plane, a configuration that facilitates collection of chips produced by machining is obtained. In fact, these chips fall through gravity and/or due to the effect of the thrust imparted by the machining tools, under the plane on which the aforesaid axes lie. A conveyor can be positioned here, under the support and rotation unit, to collect the machining chips. It is advantageous to provide a conveyor here to collect the machining chips. In some embodiments, the conveyor can extend and move in a direction substantially parallel to the support and rotation axes of the workpieces to be machined. In other embodiments, the conveyor can have a width such as to cover the whole of the machining area of the machining heads and move orthogonally to the support and rotation axes. In yet further embodiments, for example if the conveyor moves orthogonally to the support and rotation axes, it can consist of a plurality of conveyors side by side, each of a width smaller than the total width.

The rotary tool carried by the machining head can be a milling cutter, a guide roller of an abrasive or sanding belt, a rotary disc cutter, or the like. In some embodiments, the rotation axis of the rotary tool is oriented at 90° with respect to the axes of the first and of the second pair of support and rotation members and parallel to the plane on which said axes of the first and of the second pair of support and rotation members lie.

Although in the simplest embodiment the turning center can have a single machining head, in general several machining heads, for example two, three or even more machining heads, with various types of tools, will preferably by provided. Each machining head can comprise its own rotary tool and the tools of each machining head can differ from the tools of all the other machining heads. In some embodiments, the rotary axis of each of these tools is parallel to the plane on which the axes of the first and of the second pair of support and rotation members lie. Moreover, each rotary axis is parallel or orthogonal to the axes of the first and of the second pair of support and rotation members, according to the type of tool. For example, a milling cutter has its rotation axis orthogonal to the axes of the headstocks and tailstocks, while a disc cutter has its rotation axis parallel to the axes of the headstocks and tailstocks.

It would also be possible for one or more of the machining heads of the turning center to be movable about a preferably numerically controlled pivoting axis, to incline the rotation axis of the respective rotary tool, maintaining it parallel to the plane on which the axes of the two pairs of support and rotation members lie. In this way, for example, the guide rollers of a sanding belt, or a milling cutter, can be arranged with their rotation axis inclined by a different angle to 90° with respect to the axes of the headstocks and tailstocks. Moreover, the axis of a disc cutter can be positioned inclined with respect to the axes of the headstocks and tailstocks rather than parallel thereto.

When the turning center comprises several machining heads, these can be carried by a common slide, movable along the first numerically controlled translation axis, parallel to the axes of the first and of the second pair of support and rotation members. In this way, a single numerically controlled translation axis allows the movement of each machining head along the direction parallel to the axes of the headstocks and tailstocks to be carried out.

Advantageously, each machining head can be provided with a movement toward and away from the workpiece to be machined, i.e., a movement in a direction orthogonal to the plane on which the axes of the first and of the second pair of support and rotation members lie. These movements can be controlled by a number of actuators equal to the number of machining heads and can be a numerically controlled movement. However, it would also be possible for the movement toward and away from the workpieces to be machined to be controlled by a number of actuators smaller than the number of machining heads. Moreover, said movement can be not numerically controlled.

When several machining heads are carried on a common slide movable parallel to the axes of the first and of the second pair of support and rotation members, each machining head can be carried by its own slide or carriage on the common slide, to be able to move with respect to the common slide, independently from the other machining heads in a direction orthogonal to the rotation axes of the two pairs of support and rotation members.

In some embodiments, the turning center can comprise a load-bearing gantry structure. In this way, the slide that carries the support and rotation unit of the workpieces to be machined can be easily mounted on a bed under the gantry structure.

The gantry structure can have a horizontal cross member carried by a pair of uprights. Advantageously, the cross member can be substantially parallel to the rotation axes of the first and of the second pair of support and rotation members. Moreover, the machining head or heads with which the turning center is equipped can be supported on a first side of the cross member and movable there along according to the first numerically controlled translation axis.

When the turning center comprises a first slide that supports one or more machining heads, the first slide can be mounted movable along guides integral with the cross member of the gantry structure.

As mentioned above, to provide the relative movement between the support and rotation unit and the machining head or heads, in particularly advantageous embodiments, the support and rotation unit can be carried on a second slide, movable along a second preferably numerically controlled translation axis, orthogonal to the axes of the first and of the second pair of support and rotation members, and parallel to the plane on which the axes of the first and of the second pair of support and rotation members lie.

In other embodiments, the support and rotation members can be carried by a stationary support structure, for example a bed. In any case, the support and rotation members are preferably mounted in a cantilever fashion, so as to facilitate collection of the chips produced by machining in an area under the volume in which the workpieces to be machined are located during the machining cycle, i.e., the volume in which tools and workpieces being machined are positioned during mutual interaction between workpieces being machined and tools.

If the turning center is provided with a gantry structure, the second slide can be mounted movable on guides carried by a bed placed under the gantry structure. The guides can be orthogonal to the cross member of the gantry structure.

To carry out other machining operations, the turning center can also comprise an electrospindle for a further rotary tool, for example a milling cutter or a boring bit. This electrospindle can be adapted to take a position in which the rotation axis of the spindle and of the tool is not parallel to the plane on which the axes of the first and of the second pair of support and rotation members lie. In some cases, the axis of the electrospindle can have a fixed position, orthogonal to the plane on which the rotation axes of the first and of the second pair of support and rotation members of the workpieces to be machined lie.

However, the electrospindle is preferably provided with at least one numerically controlled rotation axis substantially parallel to the plane on which the axes of the first and of the second pair of support and rotation members lie and possibly orthogonal or parallel to the first translation axis. This numerically controlled rotation axis can be orthogonal to the rotation axis of the spindle and of the tool. A second numerically controlled rotation axis, not parallel and preferably orthogonal to the first numerically controlled rotation axis, can also be provided. In this way, the electrospindle is configured as a “bi-rotary” head, i.e., numerically controlled to move about two oscillation or rotation axes to allow the rotation axis of the electrospindle and of the respective tool to take various possible inclinations in space with respect to the workpiece to be machined.

The electrospindle can be multiple, i.e., can be configured for mounting two or more tools. For example, the electrospindle can be double, to mount four tools oriented at 90° one with respect to the other.

The electrospindle can be provided with a movement toward and away from the plane on which the axes of the first and of the second pair of support and rotation members lie. This movement can be controlled according to a numerically controlled translation axis. Moreover, the electrospindle can be provided with a translation movement according to a numerically controlled translation axis parallel to the axes of the first and of the second pair of support and rotation members.

For example, the electrospindle can be carried by the same slide that carries the machining head or heads. In this case, in some embodiments the electrospindle can in turn be movable, by means of an own slide, with respect to the slide that carries the other machining heads, to be able to perform movements toward and away from the plane on which the axes of the first and of the second pair of support and rotation members lie.

The turning center can comprise a further third slide, movable along the bed on which the second slide moves and provided with a movement parallel to the movement of the second slide that carries the support and rotation unit.

Advantageously, the movements of the second slide and of the further third slide along the bed can be controlled according to two numerically controlled translation axes independent from and parallel to each other, so that the relative position between the second and the further third slide can vary during the machining cycle, for the purposes that will be apparent hereunder, with reference to the second embodiment described.

Advantageously, the further third slide can comprise support and blocking members of the workpieces to be machined, which are adapted to leave the ends of the workpieces free, so as to allow end machining operations by means of a specific machining unit.

With this arrangement, during a machining cycle it is possible to machine both the lateral surface and the end surfaces of the workpieces, simply by passing semi-finished workpieces from one to the other of the second and of the further third slide.

In advantageous embodiments, when the turning center comprises a gantry structure, the bed on which the second and the further third slide move can extend beyond the gantry structure, on one side of the gantry structure opposite the side on which the machining head or heads is or are carried. In this way, while one or two workpieces are held by the support and rotation unit in the machining position with respect to the machining head or heads, the further third slide can translate one or two semi-finished or unworked workpieces to an area, at a distance from the volume in which the machining heads move, in which the machining operations on the ends of the workpieces can be carried out.

For this purpose, to simplify the structure of the turning center and make it compact, the same cross member that carries the machining heads can also carry a machining unit comprising at least one spindle movable along a plurality of numerically controlled axes. The machining unit can be carried on the side of the cross member opposite the side carrying the machining head or heads that machine the workpiece when this is held by the support and rotation unit.

The machining unit is advantageously movable along a numerically controlled translation axis parallel to the cross member, hence parallel to the first numerically controlled translation axis, in a direction parallel to the axes of the first and of the second pair of support and rotation members.

### BRIEF DESCRIPTION OF THE DRAWINGS

The invention will be better understood by following the description and the accompanying drawings, which illustrate non-limiting examples of embodiments of the invention. More in particular, in the drawing:

FIG. 1 shows a front view according to I-I of FIG. 2 of a turning center in an embodiment;

FIG. 2 shows a plan view according to II-II of FIG. 1;

FIG. 3 shows a section according to of FIG. 2;

FIGS. 4(A) and 4(B) show sections according to the line IV-IV of FIG. 1 in two operating conditions;

FIGS. 5(A) and 5(B) show sections according to the line V-V of FIG. 1 in two operating conditions;

FIGS. 6(A) and 6(B) show sections according to the line VI-VI of FIG. 1 in two operating conditions;

FIG. 7 shows a view according to VII-VII of FIG. 8 of a turning center in another embodiment;

FIG. 8 shows a plan view according to VIII-VIII of FIG. 7;

FIG. 9 shows a section according to IX-IX of FIG. 8;

FIG. 10 shows a view according to X-X of FIG. 9;

FIG. 11 shows a front view, according to XI-XI of FIG. 2, of a turning center in a further embodiment;

FIG. 12 shows a plan view according to XII-XII of FIG. 11;

FIGS. 13A, 13B show a section according to the plane XIII-XIII of FIG. 11 in two operating conditions;

FIG. 14 a shows a section according to the plane XIV-XVI of FIG. 11;

FIGS. 15A, 15B show a section according to the plane XV-XV of FIG. 11 in two operating conditions; and

FIGS. 16A, 16B show a section according to the plane XVI-XVI of FIG. 11 in two operating conditions.

### DETAILED DESCRIPTION OF EMBODIMENTS

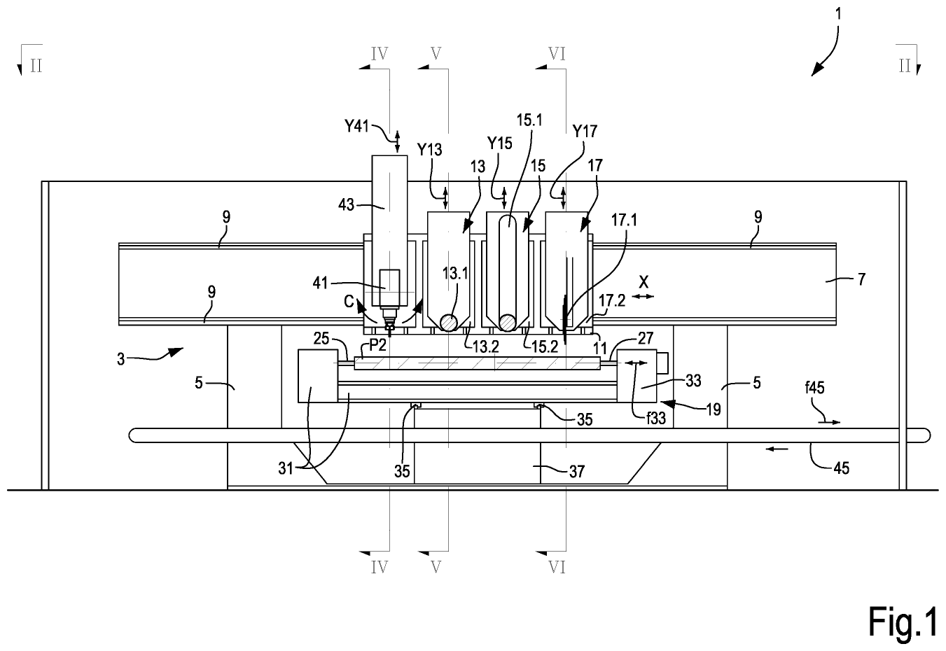

### Embodiment of FIGS. 1 to 6

An embodiment of a turning center is illustrated in FIGS. 1 to 6. The turning center is indicated as a whole with 1. In the illustrated embodiment, the turning center 1 comprises a load-bearing gantry structure 3. The gantry structure 3 comprises two uprights 5 and a horizontal cross member 7.

Horizontally extending guides 9 are provided on one side of the cross member 7. A first slide 11 is movable along the guides. The first slide 11 moves according to a first numerically controlled translation axis indicated with X.

In some embodiments, the first slide 11 carries at least one machining head, which is equipped with at least one tool for chip removal. In the embodiment illustrated in FIGS. 1 to 6, three machining heads indicated with 13, 15 and 17 are provided on the first slide 11. Reference numbers 13.1, 15.1 and 17.1 indicate three rotary tools for chip removal carried respectively by the machining head 13, by the machining head 15 and by the machining head 17.

By way of example, in the particularly advantageous embodiment illustrated in FIGS. 1 to 6, the first rotary tool 13.1 can be a milling cutter, for example a cylindrical milling cutter with a horizontal rotation axis orthogonal to the direction of movement of the first slide 11 according to the first numerically controlled translation axis X.

The second rotary tool 15.1 can comprise a sanding belt that can be guided around two guide rollers, one of which is motorized. The guide rollers of the sanding belt can be arranged with their rotation axes horizontal and orthogonal to the first numerically controlled translation axis X.

The machining heads 13, 15, 17, and more precisely their machining tools 13.1, 15.1, 17.1 can machine one or two workpieces indicated with P1 and P2, carried by a support and rotation unit 19. As will be described in detail hereunder, the support and rotation unit 19 is adapted to selectively support a single workpiece P or two, preferably identical, workpieces P1, P2. In some embodiments, when two workpieces to be machined are carried simultaneously by the support and rotation unit, said workpieces can rotate about their own axis independently from each other.

To support alternatively a single workpiece P or two workpieces P1, P2 to be machined, the support and rotation unit 19 comprises a first pair of support and rotation members and a second pair of support and rotation members. The two support and rotation members of each pair are aligned with each other along a respective rotation axis.

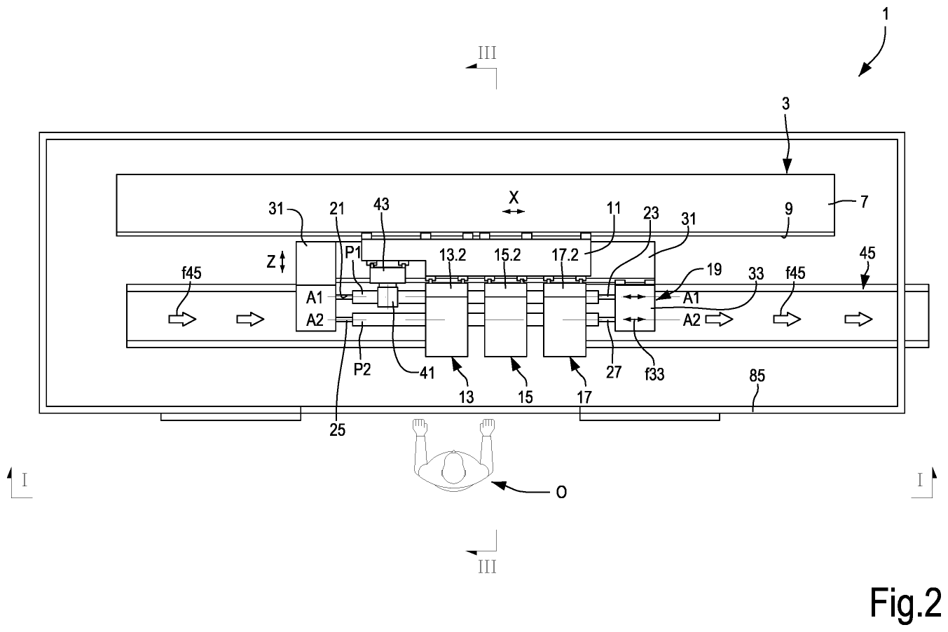

With specific reference to FIG. 2, which shows a plan view of the turning center 1, the first pair of support and rotation members comprises a first headstock 21 and a first tailstock 23, aligned along a first rotation axis A1, forming a first turning axis of the turning center 1. The headstock 21 can be motorized and the tailstock 23 can be idle. When a workpiece P1 is constrained with the ends thereof to the headstock 21 and to the tailstock 23, it can rotate about the axis A1. The rotation movement can be intermittent or continuous.

The second pair of support and rotation members comprises a second headstock 25 and a second tailstock 27, aligned along a second rotation axis A2, forming a second turning axis of the turning center 1, parallel to the axis A1. The headstock 25 can be motorized and the tailstock 27 can be idle. When a workpiece P2 is constrained with the ends thereof to the headstock 25 and to the tailstock 27, it can rotate about the axis A2. Also in this case, the rotation can be intermittent or continuous.

Each headstock 21, 25 can be provided with its own, autonomously controlled rotation motor. In this way, it is possible for each headstock to carry out a rotation movement different from that of the other headstock. By controlling the two motors synchronously, the two headstocks can also carry out exactly the same movements.

In other embodiments, a single motor, which imparts the same movement to the two headstocks 21, 25 simultaneously, can be provided. In this case, the two headstocks generally move synchronously, losing the possibility of carrying out different movements to each other.

It must be understood that this second option can be less flexible, as it offers fewer machining possibilities, in exchange for a lower cost and less complex machine. Moreover, in most cases when two workpieces are positioned on the two pairs of support and rotation members, these workpieces are subjected to identical machining operations and therefore in these cases a single drive motor is sufficient.

The movement of the drive motor or motors of the headstocks 21, 25 can advantageously be a numerically controlled movement, if controlled rotation angles are required, for example to carry out non-axisymmetric machining operations.

In general, when two workpieces are mounted on the two headstock and tailstock pairs, as will be explained in more detail hereunder, these can be machined simultaneously by a same machining head 13, 15, 17, which is arranged so that the tool thereof acts on both workpieces.

In some embodiments, the two headstock and tailstock pairs can be controlled to rotate synchronously. However, this is not essential. In some other embodiments, for example, the two headstock and tailstock pairs can rotate independently from each other, or only one of said headstock and tailstock pairs can rotate. The two tailstock and head stock pairs can rotate in the same or in opposite directions.

Headstock and tailstock are meant, in the present context, as any pair of members adapted to engage the ends of a workpiece P, P1, P2 to be machined to rotate it about the rotation axis of the headstock and tailstock.

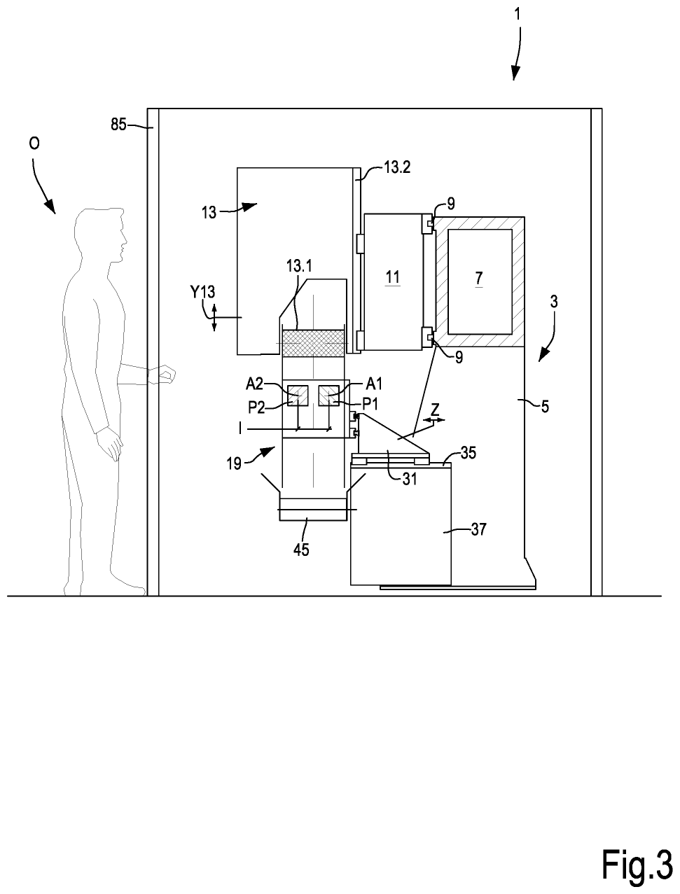

The rotation axes A1 and A2 are parallel to each other, lie on a common plane and are at a center-to-center distance I, as shown in particular in FIG. 3. In the embodiment shown the plane on which the rotation axes A1 and A2 lie is horizontal.

In the embodiment illustrated, the headstocks 21, 25 and the tailstocks 23, 27 are carried by a second slide 31. In advantageous embodiments, the mutual distance between each headstock 21, 25 and the respective tailstock 23, 27 can be adjustable. For this purpose, the headstocks and/or the tailstocks can be mounted on the second slide 31 so as to be movable in a direction parallel to the rotation axes A1, A2. In the illustrated embodiment, the tailstocks 23, 27 are carried on an adjustment carriage 33, movable along the double arrow f33 with respect to the second slide 31, while the headstocks 21, 25 are in a fixed position with respect to the second slide 31.

The second slide 31 can be provided with a translation movement along a second, preferably numerically controlled, translation axis Z. For this purpose, the slide 31 can be mounted on guides 35, integral with a bed 37 placed underneath the cross member 7 of the gantry structure 5, as shown in particular in the section of FIG. 3.

As shown in FIGS. 2 to 6, the support and rotation unit 19 is mounted on the slide 31 so that the support and rotation members, in particular the headstock and tailstock pairs 21, 23 and 25, 27, are arranged in a cantilever fashion with respect to the slide 31. Moreover, in the machining position, the support and rotation members, in the example illustrated consisting of the headstock and tailstock pairs 21, 23 and 25, 27 are positioned, by means of the slide 31, so as to be cantilevered with respect to the bed 37. This facilitates collection of the chips produced by machining at the side of the bed 37, preventing chips from falling onto the slides 35.

The movement along the second numerically controlled translation axis Z allows the headstock and tailstock pairs 21, 23 and 25, 27 to be moved with respect to the first slide 11. More in particular, the direction of the movement along the second numerically controlled translation axis Z is orthogonal with respect to the direction of the movement along the first numerically controlled translation axis X and consequently, in the example illustrated, is orthogonal to the cross member 7.

The numerically controlled axes X and Z allow the workpieces P, P1, P2 and the tools 13.1, 15.1, 17.1 to be moved with respect to one another to carry out the various machining operations required by each specific machining cycle. More in particular, the relative movement along the second numerically controlled translation axis Z allows centering of the tools 13.1, 15.1, 17.1 with respect to one or other of two workpieces P1, P2 constrained on the two headstock 21, 25 and tailstock 23, 27 pairs, or centering of the tool with respect to the two workpieces P1, P2, or centering of the tools with respect to a single workpiece P to be machined, which can be mounted between headstock 21 and tailstock 23, or preferably between headstock 25 and tailstock 27.

A further movement is provided along a third vertical translation axis between the workpieces to be machined P, P1, P2 and the tools 13.1, 15.1 and 17.1 of the machining heads 13, 15 and 17 to move the machining heads toward and away from the workpieces to be machined. This movement is advantageously assigned to the machining heads 13, 15, 17 and can be controlled with a numerically controlled translation axis and preferably with an independent numerically controlled translation axis for each machining head. In other embodiments, the movement on this axis may not be numerically controlled, but can rather be a simple movement between an idle position and a machining position.

In some embodiments, a single actuator can be provided to move all the machining heads, or some of these heads, along this third translation axis. However, in the embodiment illustrated, each machining head 13, 15, 17 is preferably provided with a movement along its own third numerically controlled translation axis. In this way each machining head can move along the third axis independently from the others.

For this purpose, each machining head 13, 15, 17 is mounted on the common slide 11 by means of an own autonomous slide or carriage, indicated with 13.2, 15.2, 17.2 respectively, which have vertical guides engaged with shoes integral with the common slide 11. The third, preferably numerically controlled, translation axis is indicated with Y13 for the machining head 13, with Y15 for the machining head 15 and with Y17 for the machining head 17. The axes Y13, Y15, Y17 are parallel to one another and orthogonal to the axes X and Z described above.

The guides and the shoes that allow the movement between machining head and common slide 11 are shown in particular for the machining head 13 in FIG. 3.

As can be seen in FIGS. 1, 2 and 3, the machining heads 13, 15 and 17 are located in a position over of the support and rotation unit 19. The vertical movement according to the translation axes Y13, Y15 and Y15 is therefore a vertical movement of each single machining head 13, 15, 17 toward and away from the workpieces P, P1, P2 supported between the headstock and tailstock pairs 21, 23 and 25, 27.

In the illustrated embodiment, the turning center 1 further comprises an electrospindle 41, which can be carried by a slide 43. The slide 43 and consequently the electrospindle 41 can be provided, with respect to the workpieces to be machined P, P1, P2, with three translation movements along three axes, preferably orthogonal to one another. The movement along these three axes can be numerically controlled movements. Advantageously, two of the three translation movements are along the first numerically controlled translation axis X (movement assigned to the electrospindle (41) and along the second numerically controlled translation axis Z (movement assigned to the workpieces P, P1, P2 to be machined). These movements can be controlled by the same members described above that move the first slide 11 and the second slide 31. For this purpose, the electrospindle 41 and its slide 43 can be mounted on the first common slide 11, which carries the machining heads 13, 15, 17.

The third translation movement can be a movement according to a vertical axis Y41, parallel to the axes Y13, Y15, Y17. This third movement can be obtained by means of the slide 43 that translates with its guides engaged in shoes integral with the common slide 11. The movement along the axis Y41 is an approach and forward movement, that can serve to carry a tool, for example a boring bit, a straight cutter or the like, to the workpiece P, P1 or P2 and to move the tool forward during the machining operation. The axis Y41 is parallel to the rotation axis of the tool carried by the electrospindle 41.

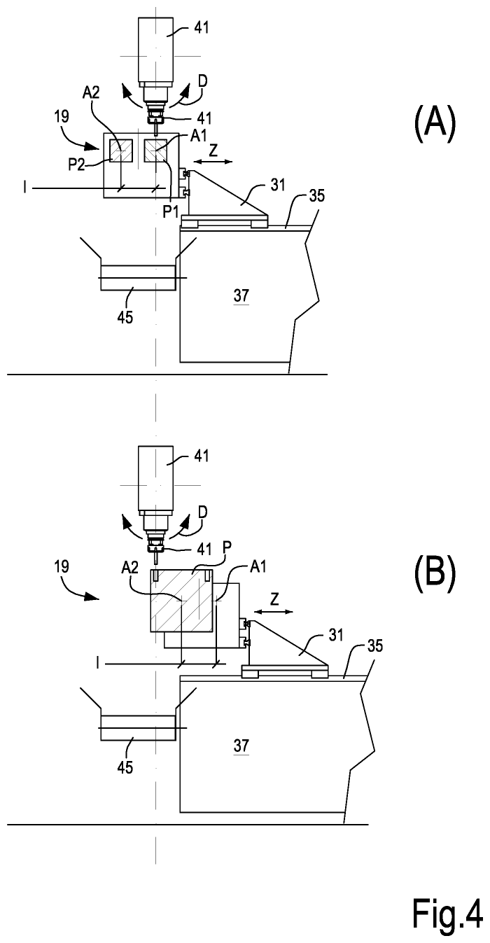

In advantageous embodiments, the electrospindle 41 can be provided with further numerically controlled movements. For example, the electrospindle 41 can be provided with a rotation or oscillation movement about a numerically controlled rotation axis indicated with C. In this case, the rotation axis C is parallel to the direction Z. In some embodiments, the electrospindle 41 can instead be provided with a rotation or oscillation movement about a numerically controlled rotation axis indicated with D (FIG. 4) horizontal and parallel to the rotation axes A1, A2 of the headstocks and tailstocks 21, 23 and 25, 27.

In some embodiments the electrospindle 41 has both the rotation movements according to the axes C and D and is therefore provided, with respect to the workpieces P, P1, P2, with a movement along five axes, preferably all numerically controlled, i.e., the translation axes X, Z, Y41 and the rotation axes C and D.

The electrospindle 41 allows machining operations that the machining heads 13, 15, 17 are not able to carry out, for example bores that penetrate laterally into the workpiece to P1 or P2 be machined.

By arranging the support and rotation unit 19 of the workpieces P, P1 and P2 to be machined under the machining heads 13, 15, 17 and under the electrospindle 41, the chips produced by the machining operations can be collected in a simple manner and in a limited area. In fact, these chips collect under the support and rotation unit 19 as a result of gravity and/or as a result of the kinetic energy imparted by the tools of the machining heads.

To collect and remove the chips efficiently, in the illustrated embodiment a conveyor 45 is provided. This conveyor has a forward movement according to the arrow f45 parallel to the rotation axes A1, A2 and to the first translation axis X. Advantageously, the conveyor 45, for example in the form of a conveyor belt, has a length equal to or greater than the travel stroke of the first slide 11, so as to collect the chips produced in any position in which the machining tools of the turning center 1 are located. Due to the aforesaid cantilevered arrangement of the headstock and tailstock pairs 21, 23 and 25, 27 with respect to the second slide 31 and with respect to the bed 37, collection of the chips on the conveyor 45 placed at the side of the bed 37 and their removal are facilitated.

The operation and multiple advantages of the turning center 1 described above will be better understood with reference to FIGS. 4(A), 4(B), 5(A), 5(B), 6(A), 6(B), which represent sections along the planes IV-IV, V-V and VI-VI of FIG. 1. The figures marked with (A) indicate an operating condition in which two workpieces P1, P2 to be machined in the same machining cycle are mounted on the support and rotation unit 19, while the figures marked with (B) indicate a condition in which the turning center 1 machines a single workpiece P at a time, of larger radial size with respect to the workpieces P1 and P2.

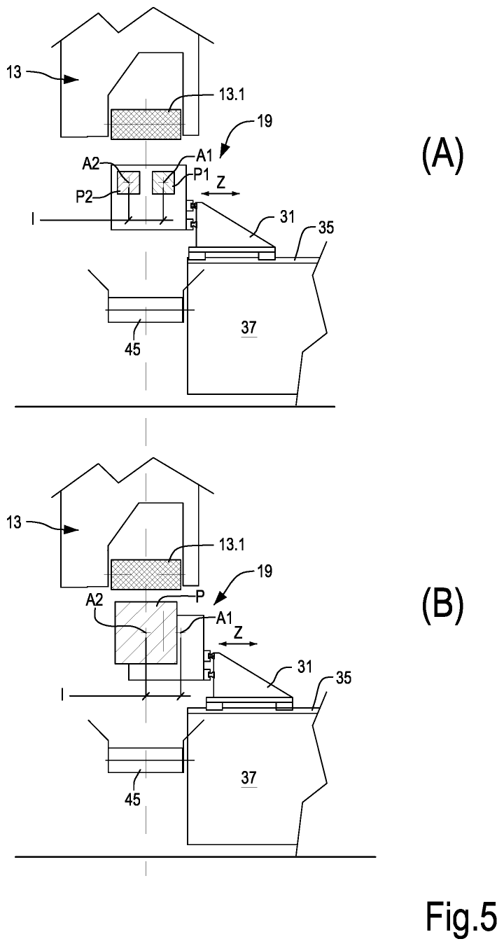

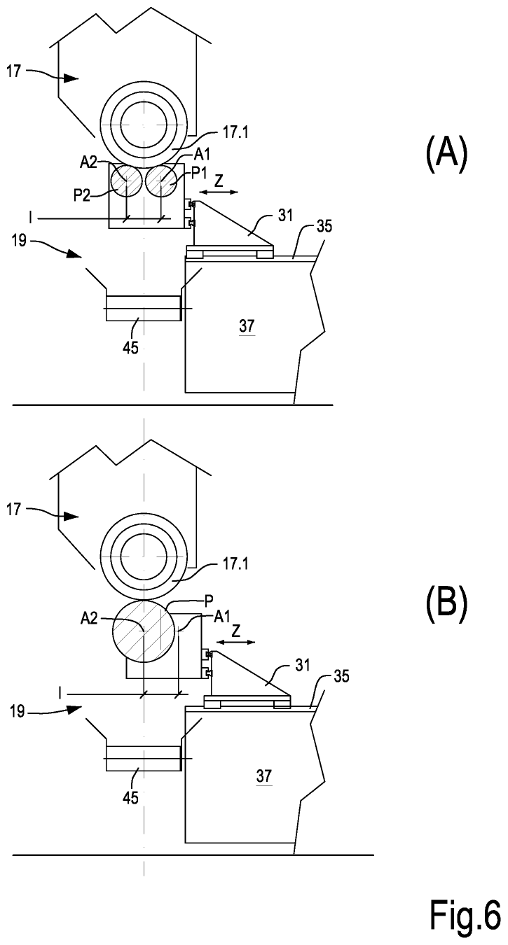

FIGS. 4(A) and 4(B) show the operating area of the electrospindle 41, FIGS. 5(A) and 5(B) show the operating area of the tool 13.1, carried by the slide 13, which in the illustrated example is a milling cutter rotating about a horizontal axis orthogonal to the rotation axes A1, A2. FIGS. 6(A) and 6(B) show the operating area of the tool 17.1, which in the illustrated example is a disc cutter rotating about an axis parallel to the rotation axes A1 and A2.

As can be seen in FIG. 4(A), when two workpieces P1, P2 to be machined are present simultaneously, these are aligned with the axes A1 and A2 of the pairs of support and rotation members, i.e., of the headstock and tailstock pairs, indicated with 21, 23 and 25, 27, respectively. The electrospindle 41 can carry out machining operations on one or on the other of the two workpieces P1 and P2 by simply moving the second slide 31 along the second numerically controlled translation axis Z, orthogonal to the axes A1, A2 and parallel to the horizontal plane on which said axes A1, A2 lie.

Vice versa, when it is necessary to machine only one workpiece P of larger transverse size (FIG. 4(B)), the slide 31 translates along the axis Z by a travel equal to I/2, where I is the center-to-center distance between the axes A1 and A2 and the workpiece P held between headstock 25 tailstock 27. Alternatively, the workpiece P can also be mounted between headstock 21 and tailstock 23. The electrospindle 41 can perform the machining operations required by the machining cycle on the single workpiece P.

Both when machining a single workpiece P, and when simultaneously machining two workpieces P1, P2, the electrospindle 41 can reach any point of the lateral surface of the workpieces P1, P2 or of the workpiece P with movements along the first numerically controlled translation axis X (movement of the first slide 11) and along the second numerically controlled translation axis Z (movement of the second slide 31), as well as with the rotation about the axes A1, A2 of the workpieces P1, P2, P. The movement according to the translation axis Y41 provides the forward movement of the tool with respect to the workpiece while carrying out a single machining operation, for example a boring operation.

With reference to FIG. 5(A), it can be observed that with a suitable length in axial direction, the milling cutter 13.1 can machine the two workpieces P1 and P2 simultaneously. The machining operations can be carried out on the whole surface of the workpieces P1, P2 moving the machining head 13 and the milling cutter 13.1 along the first numerically controlled translation axis X (movement of the slide 11) and rotating the workpieces P1, P2 about the axes A1, A2. The mutual position between milling cutter 13.1 and workpieces P1, P2 in direction Z is such that the centerline of the milling cutter is approximately halfway between the two vertical planes passing through the axes A1 and A2.

FIG. 5(B) shows the mutual position between milling cutter 13.1 and single workpiece P retained between headstock 25 and tailstock 27. The slide 31 has been moved along the axis Z by a travel equal to I/2 and the centerline of the milling cutter 13.1 is aligned with the vertical plane passing through the axis A2.

Operation of the sanding belt 15.1 carried by the machining head is similar to that of the milling cutter 13.1. The sanding belt 15.1 can possibly be provided also with a reciprocating movement parallel to its rotation axis, i.e., to the rotation axis of the rollers around which the sanding belt is guided, to avoid or reduce clogging of the belt by machining waste.

FIG. 6A shows the relative position between rotary disc cutter 17.1 carried by the machining head 17 with respect to two workpieces P1, P2 being machined simultaneously. The rotation axis of the rotary disc cutter 17.1, parallel to the rotation axes A1, A2, is positioned on the vertical plane equidistant from the axes A1 and A2. The diameter of the rotary disc cutter 17.1 can be such as to machine the two workpieces P1 and P2 simultaneously.

To machine any point of the lateral surfaces of the workpieces P1, P2 the combination of the movement of the slide 11 along the first numerically controlled translation axis X with the rotation movement of the workpieces P1, P2 about to the rotation axes A1, A2 is used.

FIG. 6(B) shows the relative position between the rotary disc cutter 17.1 and a single workpiece P mounted between headstock 25 and tailstock 27. The slide 31 has been translated along the axis Z by a travel equal to I/2, i.e., half of the center-to-center distance between rotation axes A1, A2 with respect to the position of FIG. 6(A). The rotary disc cutter 17.1 can reach any point of the lateral surface of the workpiece P by means of a movement along the first numerically controlled translation axis X, in combination with the rotation of the workpiece P about the axis A2.

As can be easily understood from FIGS. 4(A)-6(B), the mutual position between the tool and the pairs of support and rotation members consisting by way of example of the two headstock and tailstock pairs 21, 23; 25, 27 can change as a function of the number of workpieces (one or two) that are machined simultaneously. In the case in which two workpieces are machined simultaneously (FIGS. 4(A), 5(A), 6(A)), the relative position between the support and rotation unit (19) and the tool being machined is preferably such that the centerline of the machining tool (median plane of the cylindrical 13.1, or plane containing the rotation axis of the tool 17.1) is in an intermediate position between the rotation axes A1, A2 of the headstock and tailstock pairs. When, vice versa, a single workpiece is machined (FIGS. 4(B), 5(B), 6(B)) the mutual position between tool and support and rotation unit is such that the tool is aligned with the axis A1 or A2 on which the workpiece to be machined is mounted and about which it rotates.

Therefore, the support and rotation unit (19) and the machining head or heads with which the turning center is provided are adapted to take at least two mutual positions for machining by a tool, alternatively: a single workpiece supported by a first pair of support and rotation members; or a pair of workpieces supported by the first pair of support and rotation members (21, 23) and by the second pair of support and rotation members (25, 27).

As mentioned previously, when a single workpiece P is machined at a time, the headstock and tailstock pair not used (in the example headstock 21 and tailstock 23) can be removed to prevent collisions with the tools. In other embodiments, the headstock 21 and the tailstock 23 can be provided with an advancing and retracting movement, for example with a pneumatic control. The advancing and retracting movement can be provided only for one of the two pairs of support and rotation members, or for both pairs of support and rotation members.

Although in the illustrated example machining of the single workpiece P takes place between the headstock 25 and the tailstock 27, leaving the headstock 21 and tailstock 23 idle, it would also be possible to use the headstock 21 and the tailstock 23, leaving the headstock 25 and tailstock 27 idle.

As can be understood in particular from FIGS. 4, 5 and 6, the turning center 1 described allows machining operations to be optimized, thus making possible to use a structure adapted for machining large workpieces P also to machine two smaller workpieces P1, P2 simultaneously, substantially doubling the productivity of the turning center 1. With the arrangement of the slides and of the machining heads, of the electrospindle and of the support and rotation unit 19 the machine is compact and hence rigid, with a limited number of actuators.

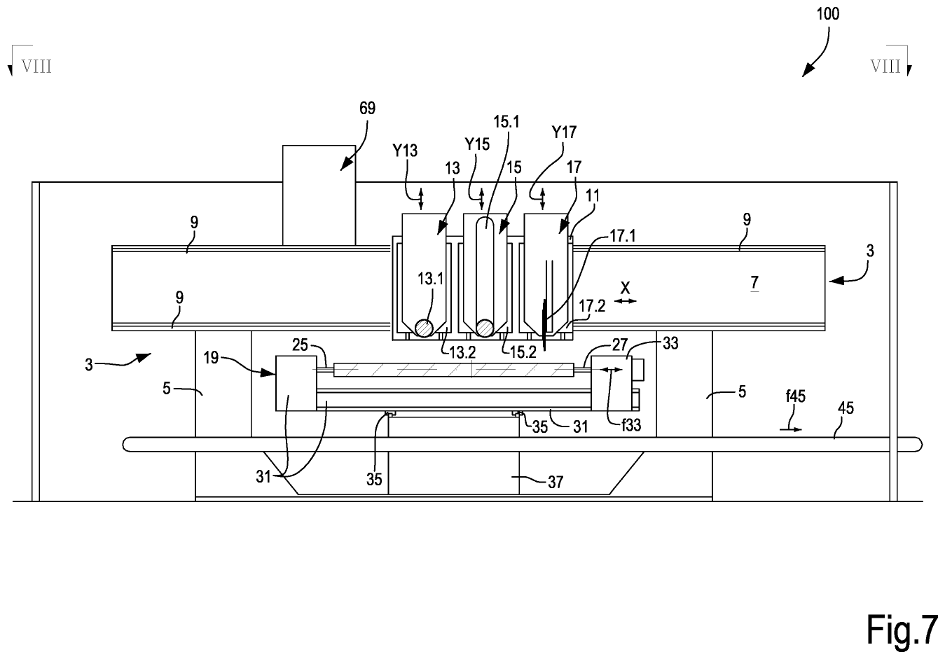

### Embodiment of FIGS. 7 to 10

The turning center 1 of FIGS. 1 to 6 does not allow the ends of the workpieces P, P1, P2 to be machined, as they are engaged with the headstocks 21, 25 and with the tailstocks 23 and 27 at all times during machining. Therefore, the workpieces P, P1, P2 must be transferred from the turning center 1 to another machine tool to carry out end machining operations.

With the aim of further increasing the capacity of the turning center, so as not to require a separate and additional machine tool to machine the ends of the workpieces P, P1, P2, the turning center can be configured as illustrated in the subsequent FIGS. 7, 8, 9 and 10. A part of the turning center of this embodiment, indicated as a whole with 100, is identical to that of the turning center 1 of FIGS. 1 to 6 and therefore will not be described again in detail. The same numbers are used in FIG. 7 to indicate the same or equivalent parts to those of the embodiment of FIGS. 1 to 6.

More in particular, in the embodiment of FIGS. 7 to 10, a gantry structure 3 with uprights 5 and cross member 7 is once again provided. The slide 11 that carries one or more machining heads 13, 15 and 17, provided with tools and with movements as described previously, moves thereon according to the first numerically controlled translation axis X.

The support and rotation unit 19 and the support and rotation members of the workpieces P, P1, P2 are substantially configured as in the turning center 1 of FIGS. 1 to 6.

Although the turning center 100 of FIGS. 7 to 10 has no electrospindle 41, it would be possible to provide an electrospindle 41 on the slide 11 also in the turning center 100.

One of the differences between the turning center 100 and the turning center 1 consists in the fact that the bed 37 of the turning center 100 has in a direction orthogonal to the gantry structure 3, a length greater than the bed 37 of the turning center 1.

Moreover, two slides are provided on the bed 37 of the turning center 100, namely: the second slide 31 that carries the support and rotation unit 19; and a further slide, hereinafter indicated as third slide 61, for the purposes explained below. The slides 31 and 61 can move on the same pair of guides 35 carried by the bed 37, but their movements along these guides is controlled by means of two independent numerically controlled axes. The numerically controlled translation axis of the slide 31 is once again indicated with Z. Instead, the numerically controlled translation axis of the slide 61, parallel to the axis Z, is indicated with Z1. As the two translation movements Z and Z1 are independent, it is possible to position the slides 31 and 61 along the bed 37 in different positions to each other and independently from each other, the only limit being to avoid collisions between the two slides 31, 61.

The slide 61 comprises support and blocking members of the workpieces P, P1, P2 that are configured to leave the ends of these workpieces free. By way of non-limiting example, in FIGS. 7 to 10 these blocking members are indicated schematically with 63 and comprise two beams 63.1 at an adjustable distance, extending in a cantilever fashion from the slide 61. For this purpose, each beam 63.1 can be fixed to a slide 63.2 adjustable along guides 63.4 integral with the slide 61 parallel to the cross member 7 and consequently orthogonal to the guides 35 of the bed 37. The double arrow f63 indicates the possibility of adjusting the position of each slide 63.2 and consequently the center-to-center distance between the beams 63.1. In other embodiments, one of the beams 63.1 can be fixed with respect to the slide 61 and the other can be adjustable.

A further difference between the turning center 1 and the turning center 100 consists in that the latter has, along the cross member 7, a second pair of guides 65, parallel to the guides 9 of the slide 11. In the illustrated embodiment, the guides 9 and 65 are arranged on opposite sides of the cross member 7.

A carriage 67 is movable along the guides 65. The movement of the carriage 67 along the guides 65 is controlled by means of a numerically controlled translation axis X1. The numerically controlled translation axis X1 is parallel to the first numerically controlled translation axis X, so that the carriage 67 moves parallel to the cross member 7 and consequently parallel to the rotation axes A1, A2 of the two pairs of support and rotation members of the workpieces P, P1, P2.

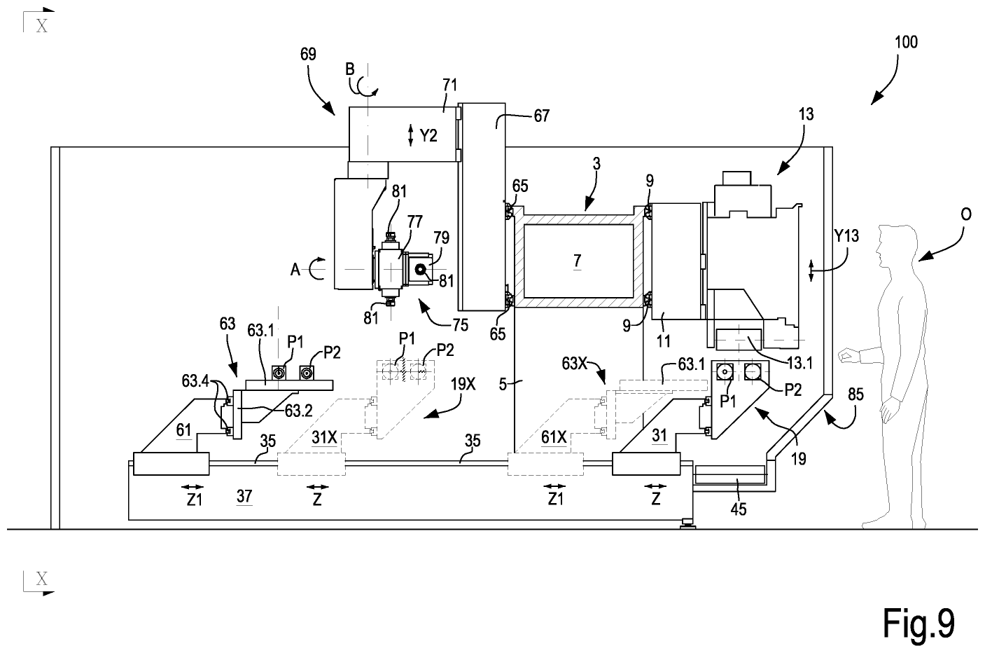

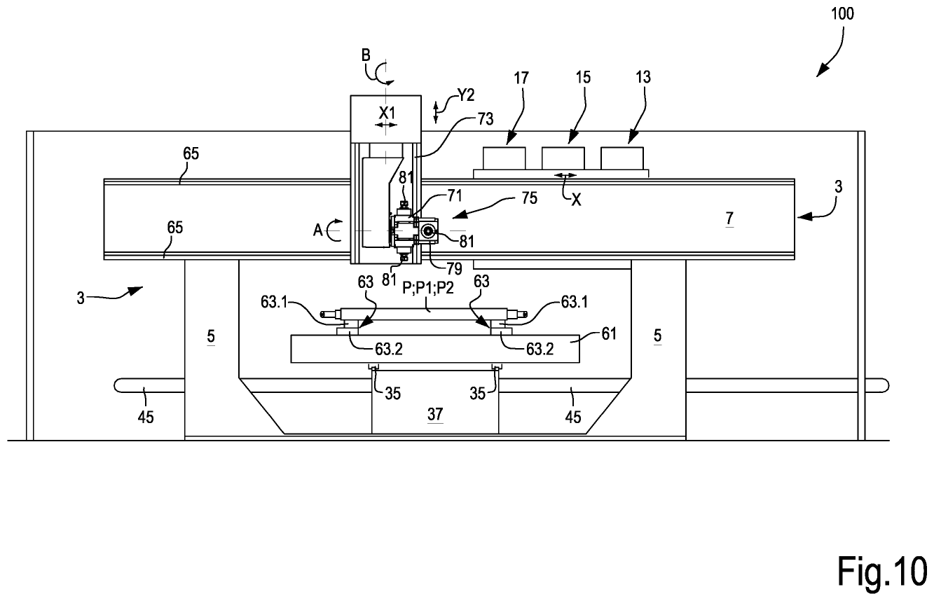

The carriage 67 carries a machining unit 69, which can be provided with one or more spindles for machining the workpieces P, P1, P2 when these are located on one or on the other of the two slides 31 and 61. In the illustrated embodiment, the machining unit 69 has a slide 71 movable vertically according to a translation axis Y2, see in particular FIGS. 9 and 10. The movement along Y2 can be a numerically controlled movement and therefore the axis Y2 can be a numerically controlled translation axis. The slide 71 can be guided along guides 73 integral with the carriage 67.

In the illustrated exemplary embodiment, a machining head 75 that carries two electrospindles 77, 79 oriented at 90° one with respect to the other and forming a crosshead, is mounted on the slide 71 of the machining unit 69. In the illustrated example each electrospindle 77, 79 is double, i.e., can carry two coaxial and opposed tools. The four tool holders of the two double electrospindles 77, 79 are indicated with 81.

In other embodiments, the machining head 75 can comprise a different configuration, for example with a single spindle or with two spindles. If necessary, a tool magazine and a tool changing device can also be provided, in order to increase the range of machining operations that can be carried out.

In the illustrated embodiment, the machining head 75 has, with respect to the slide 71, two rotation or oscillation movements about respective numerically controlled rotation axes indicated with A and B, so as to be able to select one or other of the four tools attached to the spindle-holder 81 and to incline them suitably with respect to the workpiece to be machined P, P1, P2.

FIG. 9 indicates the end of travel positions that can be taken by the two slides 31 and 61 movable along the bed 37. More in particular, 31 and 31X indicate the end positions that the slide 31 can take and 61 and 61X indicate the end positions that the slide 61 can take.

The turning center 100 illustrated in FIGS. 7 to 10 allows a plurality of machining operations to be carried out on all the faces of each workpiece P, P1, P2 with minimum intervention by the operator.

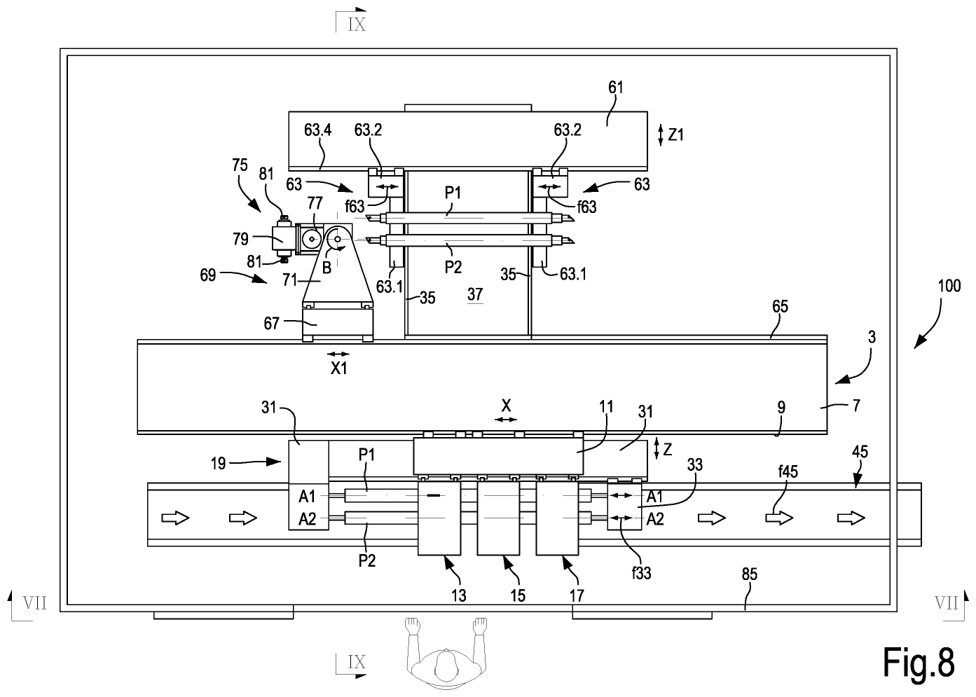

The many machining possibilities offered by the turning center 100 can be understood in particular by observing FIGS. 8 and 9. These figures show the simultaneous machining of two smaller workpieces P1, P2, but it is easily understood that the turning center 100 provides the same flexibility and numerous machining operations also for larger workpieces P, which must be machined individually.

As can be observed in particular in FIG. 9, two workpieces P1, P2 are mounted on the support and rotation unit 19 carried by the slide 31. These workpieces can be machined by the tools of the machining heads 13, 15, 17 as already described with reference to FIGS. 1 to 6, with the exclusion of the machining operations carried out by the electrospindle 41, which in this example of embodiment is not provided.

After the workpieces P1 and P2 have been machined by the tools of the machining heads 13, 15, 17, they are removed from the support and rotation unit 19, carried by the second slide 31, and placed on the third slide 61, where they are fixed on the blocking members 63. Blocking can be of mechanical or pneumatic type, for example, with mechanisms and equipment that are known and not described in detail.

Transfer of the semi-finished workpieces P1, P2 from the support and rotation unit 19 of the second slide 31 to the blocking members 63 of the third slide 61 can be carried out manually by an operator O. However, it would also be possible for the transfer to be carried out automatically, for example by means of a suitably configured robot.

To facilitate the transfer, the slides 31 and 61 can both be carried to the end positions closest to the point of access to the machine by the operator O, i.e., in the case illustrated under the first slide 11. Here the operator O can remove any finished workpieces that are located on the third slide 61, not shown in FIG. 9, and transfer the semi-finished workpieces P1, P2 from the support and rotation unit 19 to the third slide 61.

After carrying out this operation, the operator O can place another pair of unworked workpieces P1, P2 on the support and rotation members 21, 23, 25, 27 carried by the support and rotation unit 19.

After terminating these operations, the turning center 100 can be started, after closing the guards, indicated schematically with 85. The third slide 61 translates from the position 31X indicated in FIG. 9, to a position under the machining unit 69 where further machining operations can be carried out, for example end machining, by the tools carried by the machining head 75.

Simultaneously, the unworked workpieces P1, P2 that the operator placed on the support and rotation unit 19 can be machined by means of the machining heads 13, 15, 17.

FIG. 9 also shows a position in which the third slide 61 is located at the left end of the bed 37 and in this way allows the second slide 31 to be positioned (position 31X) under the machining head 75. This allows machining operations to be carried out on the workpieces P1, P2 by the tools carried by the two electrospindles 77, 79 of the machining head 75 and which can require rotation of the workpieces P1, P2 about the respective axes A1, A2 of the support and rotation unit. In practice, in this exemplary embodiment, the machining unit 69 with its machining head 75 carries out the machining operations that are carried out by the electrospindle 41 in the turning center 1.

Moreover, as previously mentioned, an electrospindle 41 can also be provided in the turning center 100, in which case machining operations such as boring can be carried out when the slide 31 is under the slide 11 by means of the electrospindle 41.

Once the machining unit 69 has carried out the machining operations on the workpieces P1, P2 that are located on the third slide 61, and possibly the machining operations of the workpieces P1, P2 that are located on the second slide 31, the workpieces can be transferred again as described above: the two slides 31, 61 are carried to the end positions on the right (FIG. 9) and the operator removes the finished workpieces P1, P2 from the third slide 61, transfers the semi-finished workpieces P1, P2 from the support and rotation unit 19 of the second slide 31 to the third slide 61 and loads unworked workpieces P1, P2 onto the support and rotation unit 19.

To further increase the productivity of the turning center, both in the version of FIGS. 1 to 6 (turning center 1), and in the version of FIGS. 7 to 10 (turning center 100), it would also be possible for the turning center to have a double system of slides 31 and a double system of slides 61 (in the version of FIGS. 7 to 10) and two beds 37 parallel to one another, positioned underneath a single cross member of a gantry structure 3. The travel of the machining heads 13, 15, 17 along the first numerically controlled translation axis X, and optionally of the machining unit 69 along the numerically controlled translation axis X1, are such as to allow the workpieces mounted alternatively on one or on the other of the two slides 31, or of the two slides 61 (if present) to be machined in a pendulum cycle. In this way, while one of the slides 31 (and optionally one of the slides 61, if present) supports the workpieces being machined, machined workpieces are unloaded and unworked workpieces are loaded onto the other slide 31 (and optionally semi-finished workpieces are transferred from the slide 31 to the other slide 61).

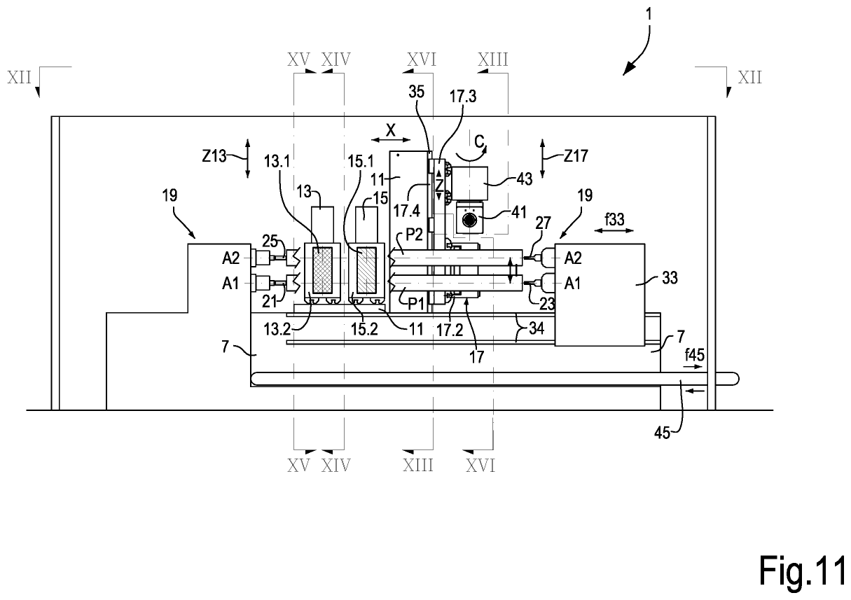

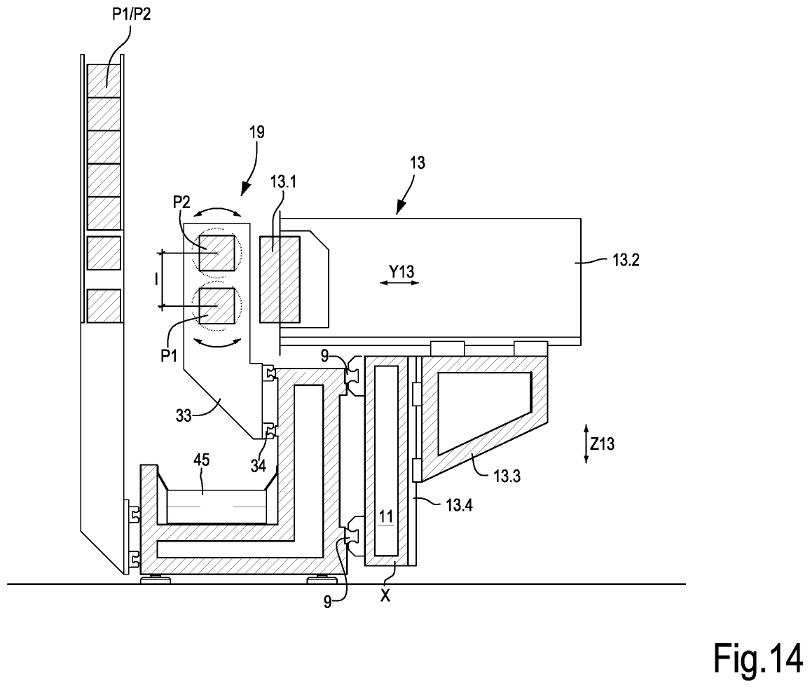

### Embodiment of FIGS. 11 to 16

A further embodiment of a turning center is illustrated in FIGS. 10 to 16. The turning center is indicated as a whole with 1. In the illustrated embodiment, the turning center 1 comprises a load-bearing structure with a movable upright on which machining heads, described below, are arranged.

The embodiment of FIGS. 11 to 16 is provided with a load-bearing structure 7 that performs the function of the cross member 7 and of the bed 37 of the previous embodiments, as the guides for a slide with movable upright that carries the machining heads are fixed thereon, as is the support and rotation unit of the workpieces to be machined. Hereunder, by analogy of terminology, the load-bearing structure 7 will also be indicated as “cross member 7”.

Horizontally extending guides 9 are provided on one side of the cross member structure 7. A first slide 11 is movable on the guides. The first slide 11 moves according to a first numerically controlled translation axis indicated with X. The slide has a function of upright movable along the bed formed by the cross member 7.

In some embodiments, the first slide 11 carries at least one machining head, which is provided with at least one tool for chip removal. In the embodiment illustrated in FIGS. 11 to 16, three machining heads indicated with 13, 15 and 17 are provided on the first slide 11. Three rotary tools for chip removal carried respectively by the machining head 13, by the machining head 15 and by the machining head 17 are indicated with 13.1, 15.1 and 17.1. In addition to the three machining heads 13, 15, 17, an electrospindle 41 is also provided.

By way of example, the first rotary tool 13.1 can be a milling cutter, for example a cylindrical milling cutter with a vertical rotation axis, orthogonal to the direction of movement of the first slide 11 according to the first numerically controlled translation axis X.

The second rotary tool 15.1 can comprise a sanding belt that can be guided around two guide rollers, one of which is motorized. The guide rollers of the sanding belt can be arranged with their rotation axes vertical and orthogonal to the first numerically controlled translation axis X.

The machining heads 13, 15, 17, and more precisely their machining tools 13.1, 15.1, 17.1, can machine one or two workpieces indicated with P1 and P2, carried by a support and rotation unit 19. As already described for the embodiment of FIGS. 1 to 10, the support and rotation unit 19 is adapted to selectively support a single workpiece P or two, preferably identical, workpieces P1, P2. In some embodiments, when two workpieces to be machined carried simultaneously by the support and rotation unit 19 are provided, the workpieces can rotate about their axis independently from each other.

To support a single workpiece P or alternatively two workpieces P1, P2 to be machined, the support and rotation unit 19 comprises a first pair of support and rotation members and a second pair of support and rotation members. The two support and rotation members of each pair are aligned with each other along a respective rotation axis.

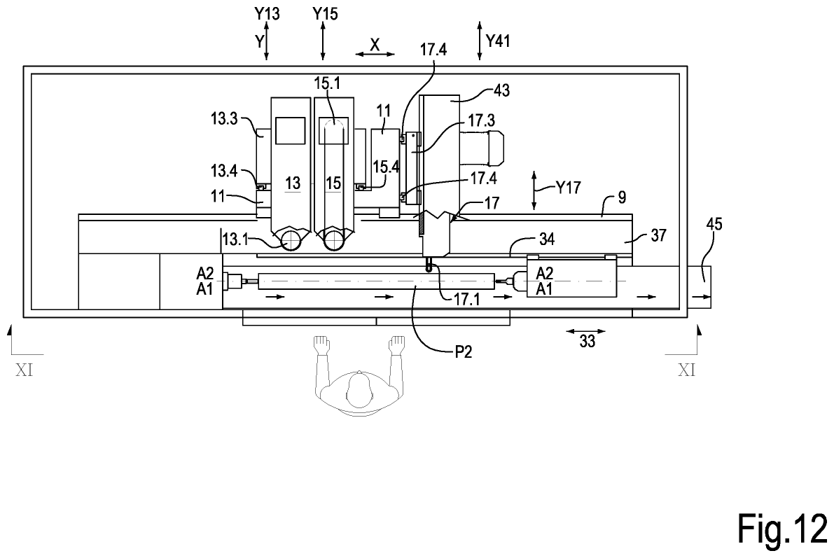

With specific reference to FIG. 12, which shows a top view of the turning center 1, the first pair of support and rotation members comprises a first headstock 21 and a first tailstock 23, aligned along a first rotation axis A1, forming a first turning axis of the turning center 1. The headstock 21 can be motorized and the tailstock 23 can be idle. When a workpiece P1 is constrained with the ends thereof to the headstock 21 and to the tailstock 23, it can rotate about the axis A1. The rotation movement can be intermittent or continuous.

The second pair of support and rotation members comprises a second headstock 25 and a second tailstock 27, aligned along a second rotation axis A2, forming a second turning axis of the turning center 1, parallel to the axis A1. The headstock 25 can be motorized and the tailstock 27 can be idle. When a workpiece P2 is constrained with its ends to the headstock 25 and to the tailstock 27, it can rotate about the axis A2. Also in this case, rotation can be intermittent or continuous.

Each headstock 21, 25 can be provided with its own rotation motor, controlled autonomously. In this way, each headstock can be made to perform a different rotation movement with respect to that of the other headstock. By controlling the two motors synchronously, it is also possible for the two headstocks to perform exactly the same movements. In other embodiments, a single motor that imparts the same movement to the two headstocks 21, 25 simultaneously can be provided.

The movement of the drive motor or motors of the headstocks 21, 25 can advantageously be a numerically controlled movement, if controlled rotation angles are required, for example to perform non-axisymmetric machining operations.

In general, when two workpieces are mounted on the two headstock and tailstock pairs, they can be machined simultaneously by the same machining head 13, 15, 17, which is arranged so that its tool acts on both the workpieces.

In some embodiments, the two headstock and tailstock pairs can be controlled to rotate synchronously. However, this is not essential. In some other embodiments, the two headstock and tailstock pairs can, for example, be rotated independently from each other, or only one of said headstock and tailstock pairs can be rotated.

The rotation axes A1 and A2 are parallel to one another, lie on a common plane and have a center-to center distance I, see in particular FIG. 11. In this embodiment the plane on which the rotation axes A1 and A2 lie is vertical.

In the illustrated embodiment, the headstocks 21, 25 are fixed with respect to the load-bearing structure 7, while the tailstocks 23, 27 are carried by an adjustment carriage 33, which allows the mutual distance between each headstock 21, 25 and the respective tailstock 23, 27 to be adjusted. The adjustment carriage 33 is movable along the double arrow f33 with respect to the load-bearing structure 7 along guides 34.

A further movement along a further translation axis is provided between the workpieces to be machined P, P1, P2 and the tools 13.1, 15.1 and 17.1 of the machining heads 13, 15 and 17, which in the embodiment illustrated in FIGS. 11 to 16 is horizontal, to move the machining heads toward and away from the workpieces to be machined. This movement is advantageously assigned to the machining heads 13, 15, 17 and can be controlled with a numerically controlled translation axis and preferably with an independent numerically controlled translation axis for each machining head. In other embodiments, the movement on this further translation axis may not be numerically controlled, but can be a simple movement between an idle position and a machining position.

In some embodiments a single actuator can be provided to move all the machining heads, or some of these heads, along this horizontal translation axis. However, in the illustrated embodiment, each machining head 13, 15, 17 is preferably provided with a movement along its own numerically controlled horizontal translation axis. In this way each machining head can move along the third axis independently from the others.

For this purpose, each machining head 13, 15, 17 is mounted on the common slide 11 by means of its own autonomous slide or carriage, indicated with 13.2, 15.2, 17.2 respectively, which have horizontal guides engaged with shoes carried by the common slide 11, or vice versa (as in the drawing) shoes integral with the slides 13.2, 15.2, 17.2, engaging horizontal guides carried by the common slide 11. The third preferably numerically controlled translation axis is indicated with Y13 for the machining head 13, with Y15 for the machining head 15 and with Y17 for the machining head 17. The axes Y13, Y15, Y17 are parallel to one another and orthogonal to the axis X described above.

The guides and the shoes that allow the movement between machining head and common slide 11 are visible in particular in FIG. 11.

Each tool 13.1, 15.1, 17.1 of the machining heads 13, 15, 17 is provided with a further numerically controlled translation movement along an axis indicated with Z13, Z15 and Z17 for the three machining heads 13, 15, 17, respectively. The axes Z13, Z15, Z17 are parallel to one another, orthogonal to the axes A1, A2 (oriented horizontally) and parallel to the plane on which the axes A1, A2 lie, which in this case is a vertical plane. Therefore, the axes Z13, Z15 and Z17 are vertical.

The numerically controlled translation movement along the vertical axes Z13, Z15, Z17 is made mechanically possible, for example, by arranging each slide or carriage 13.2, 15.2, 17.2 on a respective intermediate slide, which in turn is carried by the common slide 11 and which moves, with respect to the slide 11, along guides parallel to the axis Z13, Z15, Z17. The intermediate slides for the machining heads 13, 15 and 17 are indicated with 13.3, 15.3 and 17.3. The vertical guides, integral with the common slide 11, on which the slides or intermediate carriages 13.3, 15.3 and 17.3 translate, are indicated with 13.4, 15.4 and 17.4.

In some embodiments, two or more machining heads can be placed on a same intermediate slide. For example, the intermediate slides 13.3 and 15.3 can be joined to form a single intermediate slide that moves the machining heads 13, 15 simultaneously along the vertical direction Z.

As can be seen in FIGS. 11 to 16, the machining heads 13, 15 and 17 are in a position side by side horizontally with the support and rotation unit 19. The horizontal movement according to the translation axes Y13, Y15 and Y15 is consequently a horizontal movement of each single machining head 13, 15, 17 toward and away from the workpieces P, P1, P2 supported between the headstock and tailstock pairs 21, 23 and 25, 27.

In the illustrated embodiment, the turning center 1 further comprises an electrospindle 41, which can be carried by a slide 43. The slide 43 and consequently the electrospindle 41 can be provided, with respect to the workpieces to be machined P, P1, P2, with three translation movements along three axes, preferably orthogonal to each other, X, Y and Z, all assigned to the electrospindle. The movement along X is obtained by means of the slide 11, on which the slide 43 of the electrospindle 41 is mounted indirectly, with interposition of the slide 17.3, which also carries the machining head 17. The movement along Z is given by the movement of the intermediate slide 17.3, on which guides oriented parallel to the axes Y13, Y15 and Y17 are provided, to move the electrospindle 41 according to a numerically controlled translation axis Y41 toward and away from the workpieces P, P1, P2 carried by the headstocks and tailstocks 21, 23, 25, 27.

In advantageous embodiments, the electrospindle 41 can be provided with further numerically controlled movements. For example, the electrospindle 41 can be provided with a rotation or oscillation movement about a numerically controlled rotation axis indicated with C. In this case, the rotation axis C is parallel to the direction Z. In some embodiments, the electrospindle 41 can instead be provided with a rotation or oscillation movement about a numerically controlled rotation axis parallel to the rotation axes A1, A2 of the headstocks and tailstocks 21, 23 and 25, 27. In some embodiments, the electrospindle 41 has both the rotation movements.

The electrospindle 41 allows machining operations that the machining heads 13, 15, 17 are not able to perform, for example bores that penetrate the workpiece to be machined P1 or P2 laterally.

An area for chip collection can be arranged under the area in which the support and rotation unit 19 of the workpieces to be machined P, P1 and P2 is located and under the machining heads 13, 15, 17 and the electrospindle 41 (when the tools are in machining position), side by side with the load-bearing structure 3. In this way, the chips produced by the machining operations can be collected in a simple manner and in a limited area. In fact, these chips collect under the support and rotation unit 19 as a result of gravity.

To efficiently collect and remove the chips, in the illustrated embodiment a conveyor 45 is provided. This conveyor has a forward movement according to arrow f45 parallel to the rotation axes A1, A2 and to the first translation axis X. Advantageously, the conveyor 45, for example in the form of a conveyor belt, has a length equal to or greater than the travel stroke of the first slide 11, so as to collect the chips produced in any position in which the machining tools of the turning center 1 are located.

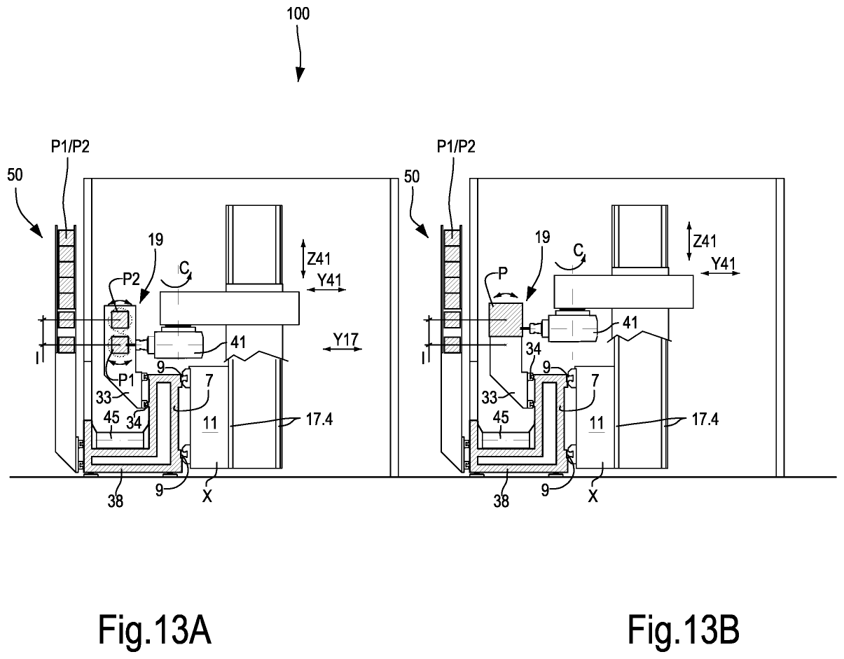

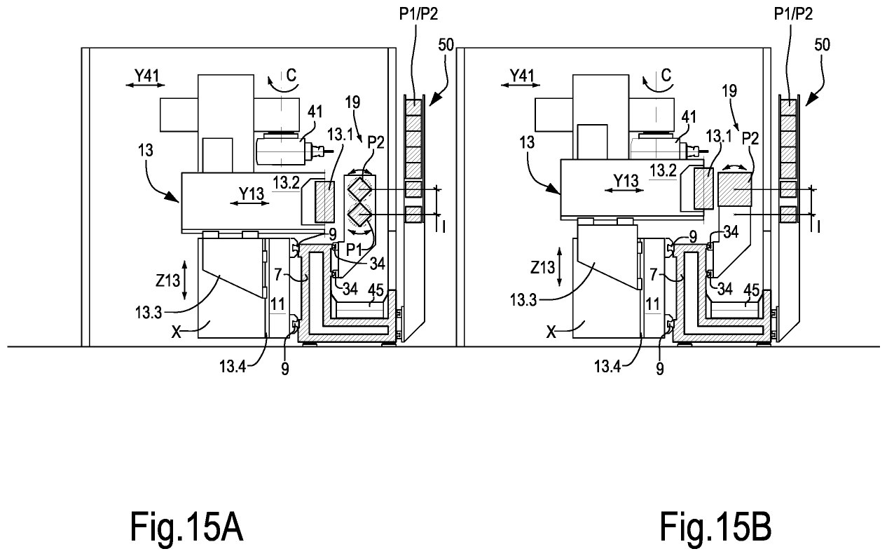

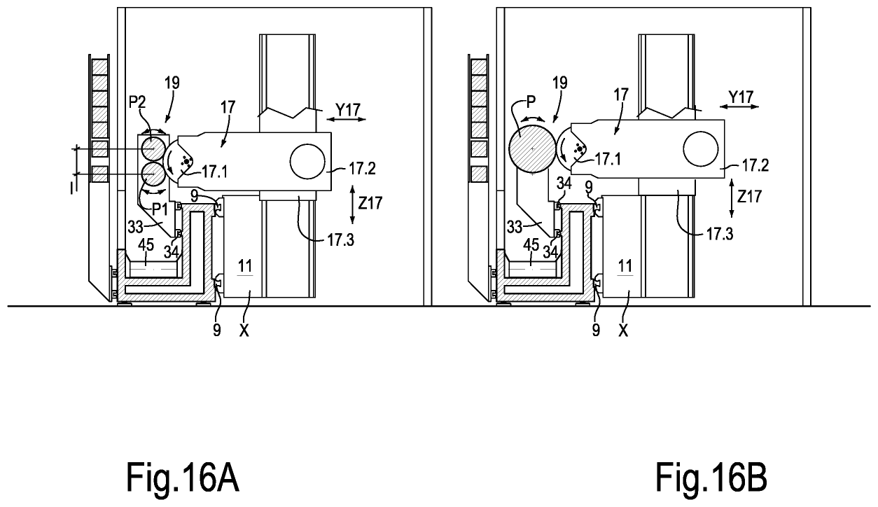

By way of example, FIGS. 13A and 13B show the electrospindle 41 operating when two workpieces P1, P2 (FIG. 13A) or a single larger workpiece P (FIG. 13B) are carried on the support and rotation unit. Analogously, FIGS. 15A, 16A show the tools 13.1 and 17.1 that simultaneously machine two small workpieces P1, P2, while FIGS. 15B, 16B show the same tools 13.1, 17.1 that machine a larger workpiece P.

Therefore, as in the previous embodiments, also in the FIGS. 11 to 16 the center-to-center distance I between the rotation axes A1, A2 of the workpieces, defined by the headstocks and tailstocks 21, 23, 25, 27 of the support and rotation unit 19 is such that a same tool can simultaneously machine two workpieces in parallel.

FIGS. 11 to 16 also schematically show a loader 50 of workpieces P, P1, P2 to be loaded on the turning center 1.

1. A numerically controlled turning center, the turning center comprising:
a support and rotation unit comprising: a first pair of support and rotation members aligned with each other along a first rotation axis, and a second pair of support and rotation members aligned with each other along a second rotation axis parallel to the first rotation axis,
at least a first machining head, comprising a first rotary tool for chip removal machining, movable according to a first numerically controlled translation axis parallel to the rotation axes of the first pair of support and rotation members and of the second pair of support and rotation members;
wherein the first machining head and the support and rotation unit are movable one with respect to the others in a direction orthogonal to the first rotation axis of the first pair of support and rotation members and to the second rotation axis of the second pair of support and rotation members and parallel to a plane on which the first rotation axis of the first pair of support and rotation members, and the second rotation axis of the second pair of support and rotation members lie; and wherein the arrangement of the tool and the center-to-center distance of the rotation axes of the first pair of support and rotation members and of the second pair of support and rotation members are such that the tool can simultaneously machine two workpieces, rotationally supported respectively by the first pair of support and rotation members and by the second pair of support and rotation members.

2. (canceled)

3. The turning center of claim 1, wherein the support and rotation unit and the at least one machining head are adapted to alternatively take: a first mutual position in which the tool of the machining head simultaneously machines two workpieces engaged with the first pair of support and rotation members, and with the second pair of support and rotation members, respectively, a second mutual position in which the tool of the machining head machines a single workpiece supported on one of said first pair of support and rotation members, and second pair of support and rotation members.

4. The turning center of claim 1, wherein the relative movement between the first machining head and the support and rotation unit is supplied to the support and rotation unit with respect to a stationary load-bearing structure.

5. The turning center of claim 1, wherein in the machining position the support and rotation unit and the rotary tool are positioned over a chip collection area, adjacent to a support structure on which the support and rotation unit is carried in a cantilever manner.

6. The turning center of claim 1, wherein: the plane on which the first rotation axis of the first pair of support and rotation members, and the second rotation axis of the second pair of support and rotation members lie is substantially horizontal; and wherein the first machining head and the support and rotation unit are movable one with respect to the other in a substantially horizontal direction.

7. The turning center of claim 5, further comprising a conveyor under the support and rotation unit, for collecting the machining chips, movable in a direction parallel to the first rotation axis and to the second rotation axis of the first pair of support and rotation members, and of the second pair of support and rotation members.

8. The turning center of claim 1, wherein the rotary tool of the first machining head rotates about an axis oriented at 90° with respect to the first rotation axis of the first pair of support and rotation members and with respect to the second rotation axis of the second pair of support and rotation members, and parallel to the plane on which the first rotation axis of the first pair of support and rotation members, and the second rotation axis of the second pair of support and rotation members lie.

9. The turning center of claim 1, comprising at least a second machining head comprising a second rotary tool for chip removal machining movable along said first numerically controlled translation axis.

10. The turning center of claim 9, wherein the second rotary tool has a rotation axis parallel to the plane on which the first rotation axis of the first pair of support and rotation members and the second rotation axis of the second pair of support and rotation members lie, and parallel or orthogonal to the first rotation axis of the first pair of support and rotation members, and to the second rotation axis of the second pair of support and rotation members.

11. The turning center of claim 9, wherein the first machining head, and the second machining head are carried by a first slide movable along the first numerically controlled translation axis.

12. The turning center of claim 1, comprising a load-bearing gantry structure, with a cross member carried by a pair of uprights, wherein the cross member is substantially parallel to the first rotation axis of the first pair of support and rotation members and to the second rotation axis of the second pair of support and rotation members; and wherein the first machining head is supported on a first side of the cross member and movable there along according to the first numerically controlled translation axis.

13. The turning center of claim 11, comprising a load-bearing gantry structure, with a cross member carried by a pair of uprights, wherein the cross member is substantially parallel to the first rotation axis of the first pair of support and rotation members and to the second rotation axis of the second pair of support and rotation members; and wherein the first machining head is supported on a first side of the cross member and movable there along according to the first numerically controlled translation axis; and wherein the first slide is movable along guides integral with the cross member of the gantry structure.

14. The turning center of claim 1, wherein the support and rotation unit is carried on a second slide, movable along a second numerically controlled translation axis orthogonal to the first rotation axis of the first pair of support and rotation members and to the second rotation axis of the second pair of support and rotation members and parallel to the plane on which the first rotation axis of the first pair of support and rotation members and the second rotation axis of the second pair of support and rotation members lie.

15. The turning center of claim 10, wherein the support and rotation unit is carried on a second slide, movable along a second numerically controlled translation axis orthogonal to the first rotation axis of the first pair of support and rotation members and to the second rotation axis of the second pair of support and rotation members and parallel to the plane on which the first rotation axis of the first pair of support and rotation members and the second rotation axis of the second pair of support and rotation members lie; and wherein the second slide is mounted movable on guides positioned under the gantry structure, and fixed to a bed underneath the cross member.

16. The turning center of claim 1, wherein each machining head is provided with a movement according to a numerically controlled axis, toward and away from the support and rotation unit, according to a direction substantially orthogonal to the plane on which the first rotation axis of the first pair of support and rotation members and the second rotation axis of the second pair of support and rotation members lie; each machining head being controlled in the movement toward and away from the support and rotation unit according to a respective independent numerically controlled axis.

17. The turning center of claim 1, further comprising an electrospindle for a further rotary tool, rotating about an axis adapted to take an orientation incident to the plane on which the rotation axes of the first pair of support and rotation members and of the second pair of support and rotation members lie.

18. The turning center according claim to at least claim 12, further comprising a load-bearing gantry structure, with a cross member carried by a pair of uprights, wherein the cross member is substantially parallel to the first rotation axis of the first pair of support and rotation members and to the second rotation axis of the second pair of support and rotation members; wherein the first machining head is supported on a first side of the cross member and movable there along according to the first numerically controlled translation axis; wherein the first slide is movable along guides integral with the cross member of the gantry structure; and further comprising a third slide, movable parallel to the second slide; wherein the movement of the second slide and of the third slide are controlled according to two numerically controlled translation axes independent from and parallel to each other; and wherein the third slide comprises support and blocking members for the workpieces to be machined adapted to leave the ends of the workpieces to be machined free; and wherein the travel along the numerically controlled translation axis of the third slide extends beyond the gantry structure, on one side of the gantry structure opposite the side on which the first machining head is carried.

19. The turning center of claim 18, wherein the cross member carries a machining unit comprising at least one spindle movable according to a plurality of numerically controlled translation axes, the machining unit being carried on the side of the cross member opposite the side on which the first machining head is carried and being movable according to a numerically controlled translation axis parallel to the cross member, wherein the spindle of the machining unit is movable about at least one numerically controlled rotation axis and about two numerically controlled rotation axes not parallel to each other; and wherein the spindle of the machining unit is also movable along one and/or two numerically controlled translation axes, orthogonal to each other.

20. The turning center of claim 1, wherein the first rotation axis of the first pair of support and rotation members, and the second rotation axis of the second pair of support and rotation members, are arranged on a substantially vertical plane and each machining head is carried by a load-bearing structure with a movable upright along a bed according to a numerically controlled translation axis parallel to the first rotation axis and to the second rotation axis.

21. The turning center of claim 20, wherein at least one machining head is movable, with respect to the load-bearing structure with movable upright, along a numerically controlled translation axis orthogonal to the substantially vertical plane on which the first rotation axis and the second rotation axis lie.

22. The turning center of claim 20, wherein at least one machining head is movable, with respect to the load-bearing structure with movable upright, along a translation axis parallel to the substantially vertical plane on which the first rotation axis and the second rotation axis lie, and orthogonal to the first rotation axis and to the second rotation axis.
